(19) United States
(12) Patent Application Publication
(10) Pub. No.: US 2020/0286401 A1
(43) Pub. Date: Sep. 10, 2020

(54) Shoe Tying Teaching Aid Device and Method

(71) Applicant: Courtney Clancy, Miller Place, NY (US)

(72) Inventor: Courtney Clancy, Miller Place, NY (US)

(21) Appl. No.: 16/296,030

(22) Filed: Mar. 7, 2019

(51) Int. Cl. G09B 19/00; A43C 9/00

(52) U.S. Cl. CPC G09B 19/0076; A43C 9/00

(57) ABSTRACT

A multi-colored shoelace is used as a teaching tool to provide visual cues to help teach an individual how to tie their shoes. The teaching method includes a sequence of seven phases. A first phase consists of a warmup exercise involving pinching the thumb and index fingers while keeping the other fingers in a closed position. A second phase consists of tying a shoe on a tabletop using a multi-colored shoelace to provide visual cues during the shoe tying. A third phase consists of tying a shoe on a tabletop using a plain colored shoelace to practice tying a show without any visual color cues. A fourth phase consists of tying a shoe while it is worn. A fifth phase consists of fine tuning techniques to improve the symmetry of the tied shoe laces. A sixth phase consists of tying a double knot and a final seventh phase consists of untying a shoe.

### CROSS REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION BY REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR A JOINT INVENTOR

Not Applicable

### FIELD OF THE INVENTION

This invention relates to footwear and more particularly to a multi-colored shoelace used as a teaching aid to assist an individual in tying a shoe and a method for tying a shoe.

### BACKGROUND OF THE INVENTION

One of the first things taught to children are basic life skills such as how to put on clothes and how to tie shoes. However, many parents of special need children on the autism spectrum have encountered difficulty in teaching their children how to tie their shoes. It is the intent of the present invention to provide an effective shoe tying method that uses a multi-colored shoelace to provide visual cues during the process.

### SUMMARY OF THE INVENTION

It is a first object of the present invention to provide a shoelace that has a plurality of different colored regions to be used as a teaching aid to learn how to tie shoes.

It is a second object of the present invention to provide a novel and effective method for teaching individuals how to tie shoes.

### BRIEF DESCRIPTION OF THE DRAWINGS

FIG. 1 is a drawing of a shoelace used as a teaching aid using the method of the present invention.

FIG. 2 is a block diagram showing the seven phases of the shoe tying method of the present invention.

FIGS. 3(a) and 3(b) are pictures showing a hand warmup pinching exercise used in the first phase of the shoe tying method.

FIG. 4 shows the incorrect way to pinch fingers together when tying a shoe in the second phase of the shoe tying method.

FIG. 5 shows a shoe with the multi-colored teaching shoelace used in the second phase of the shoe tying method.

FIG. 6 shows a shoe using the multi-colored teaching shoelace with the laces crossed to form an “X” to point the laces in the correct orientation used during the second phase of the shoe tying method.

FIGS. 7(a) through 7(o) show the steps in tying a shoe using visual cues as described in the second phase of the shoe tying teaching method.

FIG. 8(a) through 8(f) show the steps in tying a double knot used in the sixth phase of the shoe tying teaching method.

### DETAILED DESCRIPTION OF THE INVENTION

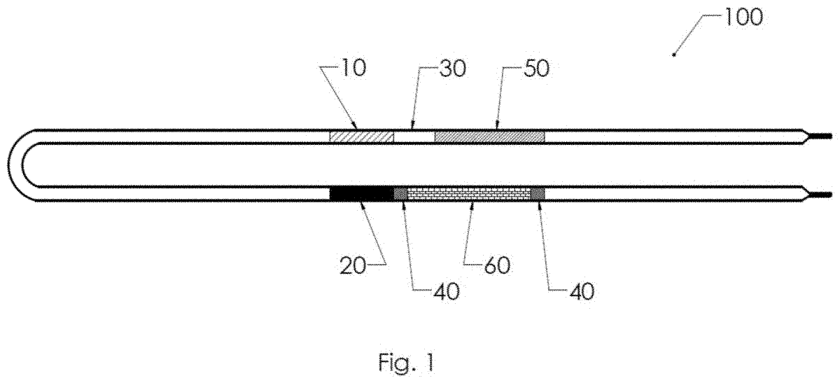

Referring first to FIG. 1, a shoelace 100 is shown having six different colored regions 10, 20, 30, 40, 50 and 60. It is preferred that the shoe lace length of the shoelace 100 is approximately 54 centimeters in length and lengths shorter than this typically be very challenging when teaching this shoe tying method. It is obvious to one skilled in the art of making shoelaces that other colors can be substituted to provide additional colored design shoelace teaching aids. In the preferred embodiment, shoelace 100 uses a red colored region 10 and an adjacent white colored region 30. Adjacent to the white colored region 30 is a purple colored region 50, and the remaining length of the shoelace up to the first aglet is the primary color used for the shoelace which is a white color in the preferred embodiment. On the opposite side and of the same length as the red colored region 10 is a blue colored region 20. Adjacent to the blue colored region 20 and having a length of approximately ⅜ inch is a pink colored region 40. Adjacent to the pink colored region 40 is a green colored region 60. The green colored region is approximately 9 times longer than the pink colored region 40. Adjacent to the green colored region 60 is a second pink colored region 40. When the shoelace 100 is arranged in position according to FIG. 1, the end of the purple colored region 50 lines up with the second pink colored region 40.

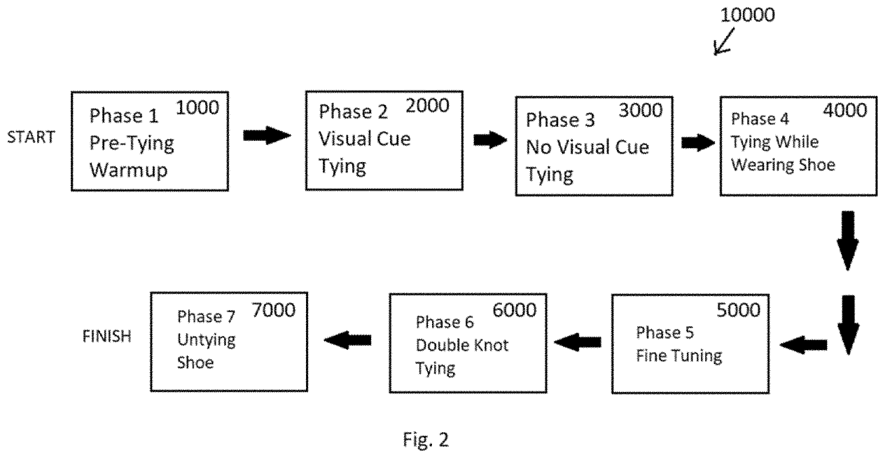

The method of tying a shoe according to the present invention shall next be described. FIG. 2 shows a block diagram of shoe tying method 10000 that is broken down into seven phases. Phase One (1000) is a Pre-Tying Warm-Up Preparation exercise. Phase Two (2000) is a Visual Cue Tying exercise and uses shoelace 100 as a teaching aid on a table. Phase 3 (3000) is a Visual Cue Elimination Tying exercise that uses a plain (white) colored shoelace as a teaching aid on a table. Phase 4 (4000) is a full shoe tying exercise where the individual is wearing the shoe during the tying exercise. Phase 5 (5000) is a fine-tuning adjustment exercise to make any adjustments in the tied shoe. Phase 6 (6000) is a double knot tying exercise. Phase 7 (7000) is a final exercise showing how to untie the shoe.

Phase One (1000) is a Pre-Tying Warm-Up Preparation exercise and consists of the following sequential tasks that are numbered 1001 thru 1006 as described next. The purpose of this first phase is to properly prepare the individual for tying his shoes by exercising the muscles of their fingers and hand. As used in this specification, individual may be either male or female and of typical age of children when individual first learn how to tie their shoes. When using the terms “he” or “his” this is meant as referring to either male or female genders in this specification and is only for purposes of brevity.

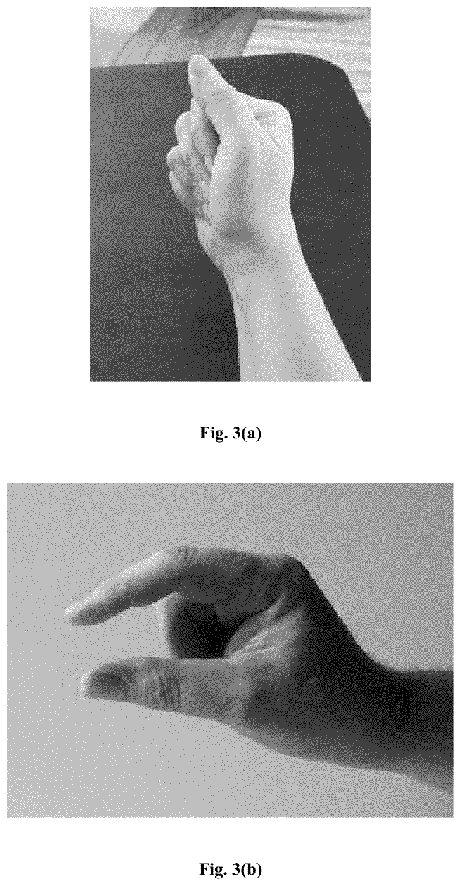

1001—Have your individual practice utilizing a pincer grasp. If he is having trouble bringing his thumb and pointer finger together, then ask him to make a first as shown in FIG. 3(a) and then pinch the thumb and index fingers together while keeping the remaining fingers closed as shown in FIG. 3(b).

1002—If individual continues to have difficulty with this task then proceed to work on the following additional activities to build up manual dexterity:
a. Stringing small beads onto a string
b. Picking up coins and placing them into a coin slot
c. Work with color coded therapy putty and pull small objects out (wooden pegs, beads, coins)
d. Clothespin activities

FIG. 3(b) shows the correct two finger pinching position. FIG. 4 shows an incorrect pinching position because the individual should not pinch with their other 3 fingers extended like the OK sign as the other fingers will get in their way during the shoe tying exercise.

1003—Individual is to lace up a sneaker with the multi-colored lace 100.

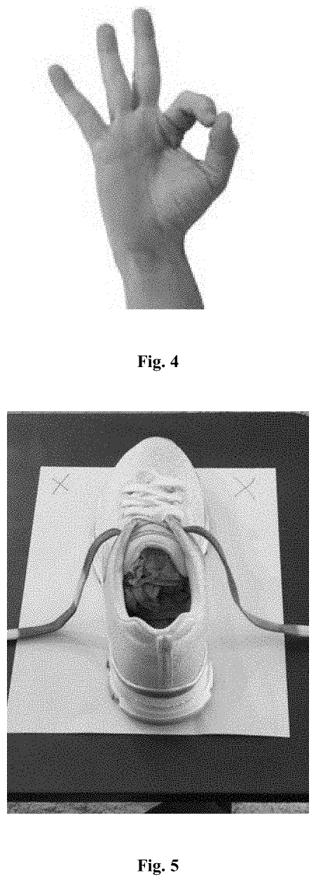

1004—Stuff the sneaker with tissue paper or newspapers to fill it out as if there was a foot inside the shoe as shown in FIG. 5.

1005—Get a white piece of computer or copier paper and make a red X at the top right corner and a blue X at the top left corner.

1006—Place the stuffed sneaker on top of the white computer paper.

Phase Two (2000) is a Visual Cue Tying based shoe tying exercise and uses the previously prepared shoe from Phase One (1000). This phase consists of steps 2001 thru 2011 as described next.

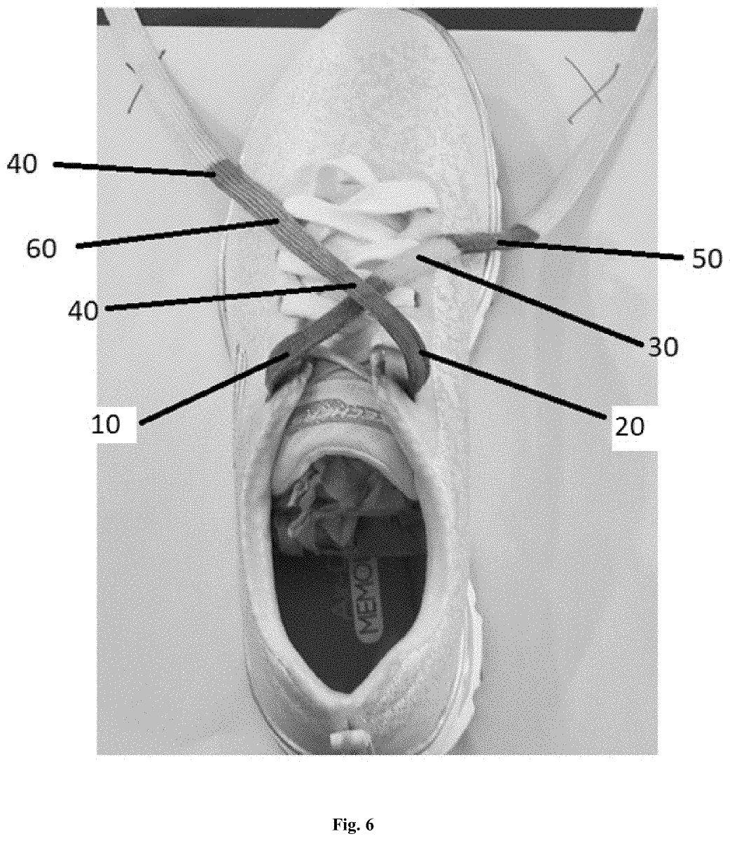

2001—Orient the multi-colored lace such that the red lace 10 goes towards the red “X” that is labeled on the computer paper and the blue lace 20 goes on the side where the blue “X” is labeled on the computer paper as shown in FIG. 6.

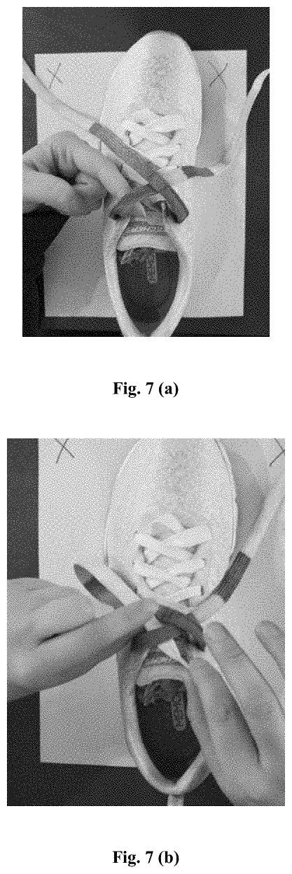

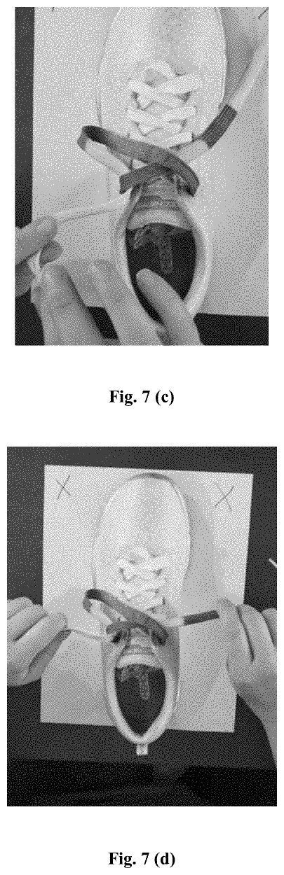

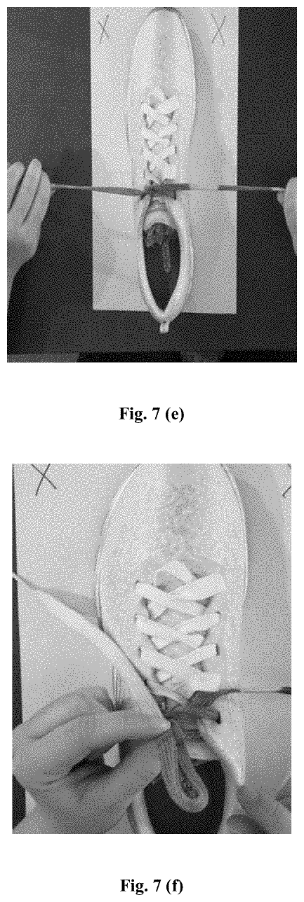

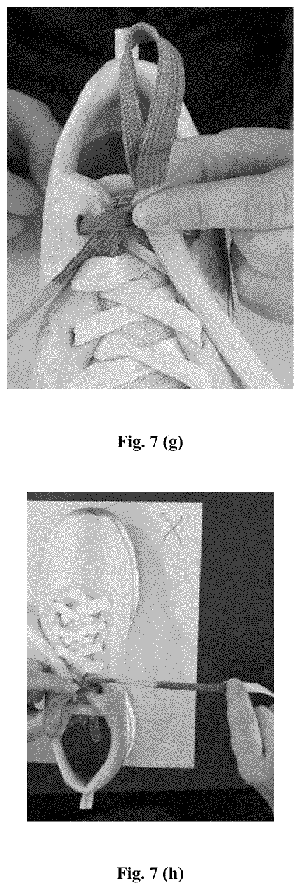

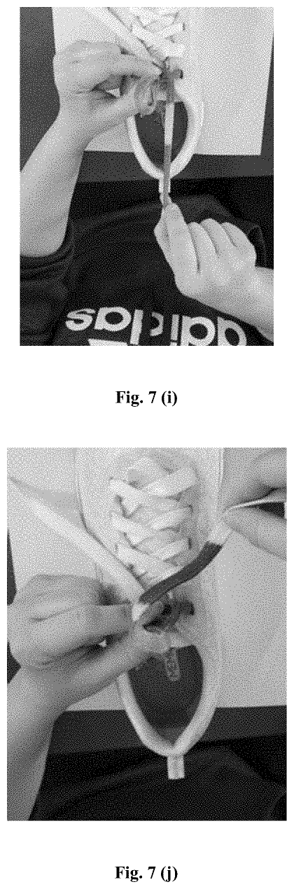

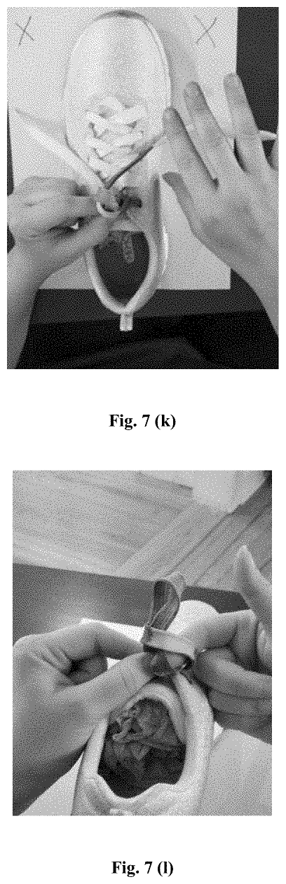

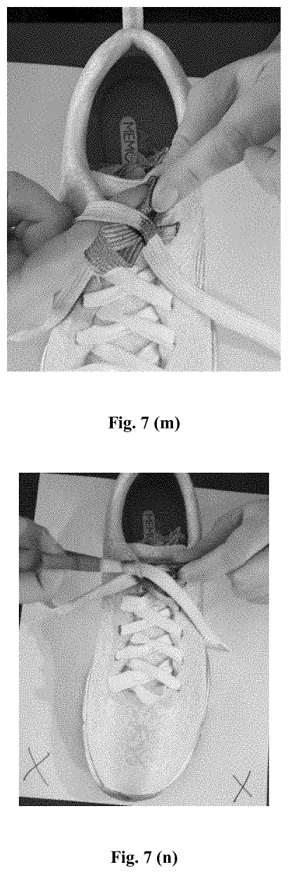

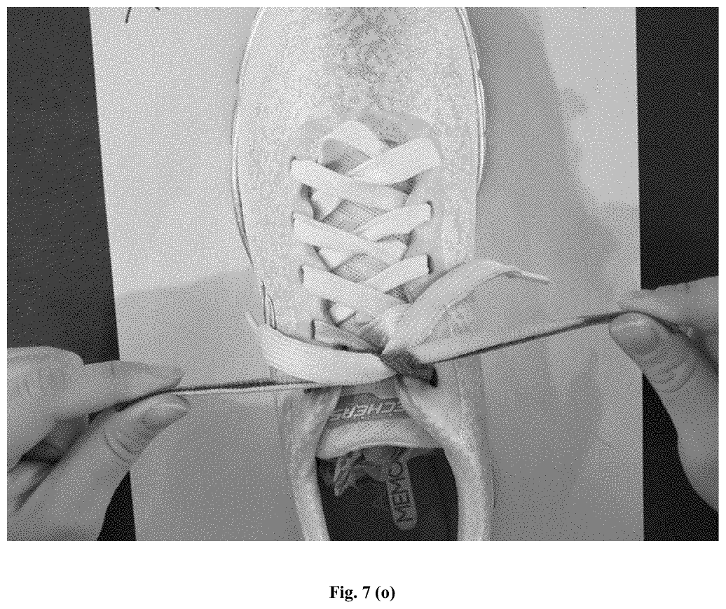

2002—Ask the individual as to which color is on top—Blue or Red? The blue lace 20 goes over the red lace 10 as shown in FIG. 7(a).

2003—Place the blue lace 20 under and in the middle and have your helping hand take it and give it back to your original hand as shown in steps in FIGS. 7(b), 7(c), and 7(d).

2004—Grab both laces and pull tight as shown in FIG. 7(e). Do not proceed past this step if individual is having trouble.

Keep practicing steps 2001 thru 2003 until the individual achieves it with no assistance or verbal cues. If individual starts to get frustrated then give them a two-minute break and come back to it.

2005—Use pincer fingers to pinch pink 40 to pink 40 together to make the “green ear” (loop made with green 60 section of lace as shown in FIG. 7(f). Ensure that their other three fingers are in the palm of their hand.

2006—Slide fingers to the bottom of the green 60 ear under the pink 40 as shown in FIG. 7(g). Make sure individual is not making the OK sign. In other words, the rest of their fingers should be in the palm of their hand.

2007—Grab the purple lace 50 while keeping the green ear pinched with the other hand as shown in FIG. 7(h). Push purple lace 50 towards your belly as shown in FIG. 7(i). Have individual give the ear a snug hug against his body. Once individual has made it around the ear, have him drop the lace while his other hand is still holding onto the green 60 ear as shown in FIG. 7(j). Instruct him to make sure the hole is not too big or else there will not be enough lace to make a second ear. Reinforce this by saying “snug hug”.

2008—This step requires the individual to think. The thumb grasping the green 60 ear is their visual cue hint that this is the hole that the new ear will push through as shown in FIG. 7(k).

2009—Push purple 50 section of lace through the hole as shown in FIG. 7(1).

2010—Pinch purple 50 ear closed as shown in FIG. 7(m). Do not let individual hook their finger or he may pull the purple laces completely through the hole leaving just one ear. The other hand can let go to pinch green 60 ear as shown in FIG. 7(n).

2011—Pull the ears tight as shown in FIG. 7(o). It is acceptable if the ears are not both the same size or if the knot is loose as these issues will be addressed in Phase Five (5000).

Phase 3 (3000) is a Visual Cue Elimination Tying exercise that uses plain colored laces and is to be done on a tabletop. The following steps 3001 thru 3003 are the parts of this exercise.

3001—After individual has achieved success in shoe-tying with the Phase Two (2000) exercise then switch him over to a shoe with plain colored laces.

3002—Repeat steps 2001 thru 2011 with exception that it is done with plain colored laces.

3003—Ask individual where the colors were as the steps are followed. As for specific colors such as where are the two pink 40 colors are.

Phase 4 (4000) is a full shoe tying exercise where the individual is wearing the shoe during the exercise. Phase 4 consists of steps 4001 thru 4003.

4001—Put the shoe on the foot of the individual.

4002—Figure out what position is most comfortable for the individual to tie his shoe. It could be sitting on the floor or standing and balancing while putting their foot up on a chair. It could be sitting on steps of a staircase. It could be sitting in a chair and bending over. If individual has a weak core and has difficulty sitting upright then it is recommended that he sit up against a wall.

4003—Repeat steps 2001 thru 2011 using a shoe with plain colored laces.

Phase 5 (5000) is a fine-tuning adjustment exercise to make any adjustments in the tied shoe full shoe tying exercise where the individual is wearing the shoe during the exercise. Phase 5 consists of steps 5001 thru 5004.

5001—Once individual has successfully tied his shoe with minimal to no verbal cues or assistance then begin this phase. Teach him the adjustments needed based on his specific needs. The example below is for fine tuning of the ear sizes.

5002—Teach the individual how to fix the ears so they are close in size to each other.

5003—Re-tighten the knot and ensure that there is not excessive length of lace left over.

5004—Use the ear “snug hug” method (previous step 2007).

Phase 6 (6000) is a double knot tying exercise and consists of steps 6001 thru 6005.

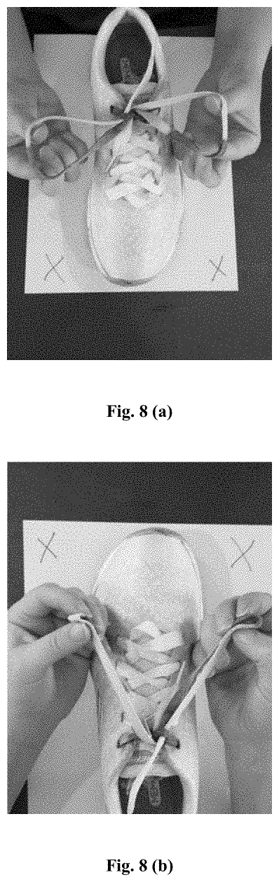

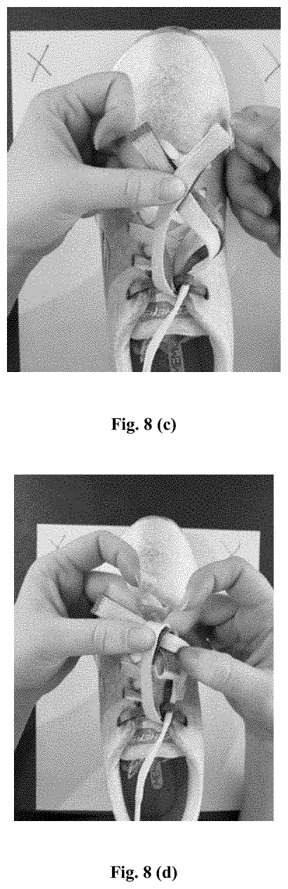

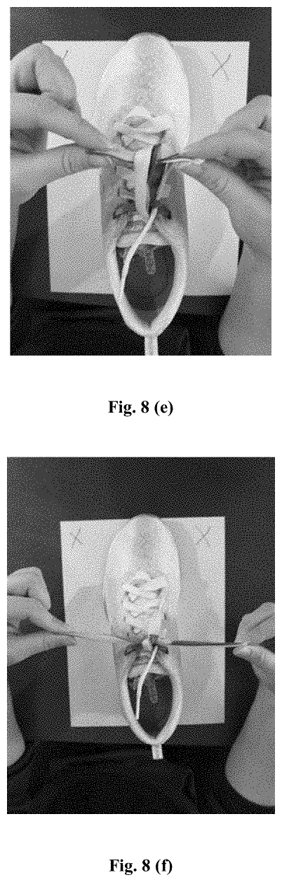

6001—Make sure that the ears are not open as shown in FIG. 8(a).

6002—Tape the ears shut using as shown in FIG. 8(b). Make an “X” by crossing the two closed ears as shown in FIG. 8(c).

6003—Ensure that the top ear goes under and in the middle of the bottom ear as shown in FIG. 8(d).

6004—Pull the top ear through the loop of the bottom ear as shown in FIG. 8(e).

6005—Pull both ears away from each other and pull tight to form the double knot as shown in FIG. 8(f).

Phase 7 (7000) is an exercise to teach how to untie the shoe and consists of steps 7001 thru 7003.

7001—Show individual where he should not pull on the laces. Explain if he pulls the ears or the end laces to untie a double knot that it makes the knot tighter.

7002—Show individual how to use his pincer fingers to pull the knot apart. Explain that this step can take some time and it may not come undone right away.

7003—Once the first knot is out then individual can pull the end of the laces to untie the bow.

What is claimed is:

1. An article of footwear comprising:
a pair of opposed flaps, each flap having an upper end and a lower end; said flap having a row of eyelets wherein there are between five and seven eyelets on each flap; and
a lace threaded through said eyelets and having seven colored regions; said colored regions being arranged in a specific orientation such that when said lace is arranged in a symmetrical “U” shape wherein there is a first side containing three different colored bands and a second side containing four colored bands;
wherein said colored bands on said first side are of three different colors and are of unequal lengths that reach a total length of approximately six inches; and
wherein said colored bands on said second side are of three different colors than said first side and that reach a total length of approximately six inches; and
wherein one of the colors in said second side occur in two of said second side bands; and
wherein said colored bands on said second side are sequentially arranged in four regions; and
wherein said first region being a color different than any colors of said first side and having the same length as said first colored region on said first side; said second region of said second side having a different color and being of a shorter length of approximately ¼ of length of said first colored region of said second side; said third region of said second side being of a different color than any other colored regions of said first or second sides and being of the longest total length of said second side colored regions; said fourth region of said second side being of the same color and length of said second colored region of said second side.

2. A method for training an individual in shoe tying using the article of footwear according to claim 1, the method comprising the following steps:
instructing said individual to warm up his finger muscles by pinching together the thumb and index fingers while curling the remaining fingers in the palm of his hand;
instructing said individual to place said footwear on a table top with a piece of white colored paper underneath said footwear; said paper having two “X” marks, one “X” mark located at a first corner of said paper and printed in a first color and a second “X” mark located on a second corner opposite to said first corner and printed in a second color;
instructing said individual to orient the footwear whereby said first colored portion of said multi-colored lace is one the same side as a first colored “X” on said paper and whereby said second colored portion of said multi-colored lace is on the other side that matches a second “X” having same color as the second colored portion of said lace;
asking said individual as to which color is on top so as to confirm that individual understands the correct orientation of said first and second colored portions on said lace;
instructing said individual in placing the second colored portion of lace under and in the middle and having the other hand take the lace and give it back to said first hand;
instructing said individual in grabbing both lace ends and pulling said lace tight;
instructing said individual to pinch the lace between his thumb and index finger to form a first loop wherein said loop consists of a third elongated colored region with two smaller and shorter length fourth colored regions whereby there is a single short length fourth colored region on each side of said elongated third colored region;
instructing said individual to slide fingers to bottom of said loop under said fourth colored ends whilst keeping the remaining fingers curled in the palm of the hand;
instructing said individual to grab a fifth colored region of said lace and push said fifth colored lace region against his belly;
instructing said individual while he is still hugging the lace with the words “snug hug”;
instructing said individual to drop said lace while his other hand is still holding onto said loop;
instructing said individual to visually identify the thumb and finger pinching said loop and that said loop will be used next to complete the tying of a knot;
instructing said individual to push said fifth colored section of lace through said hole formed by said loop;
instructing said individual to pinch said fifth colored region of lace closed to form a second loop;
instructing said individual to use his other hand to pinch said first loop; and
instructing said individual to pull said loops tight together to form the knot.

3. The method as claimed in claim 2 further comprising the following steps:
instructing said individual to remove said multi-colored lace from said footwear and replace with a plain colored lace;
instructing said individual to pinch the lace between his thumb and index finger to form a first loop and to ask individual what colors were used before to first the first loop when said multi-colored laces were used;
instructing said individual to slide fingers to bottom of said loop formed whilst keeping the remaining fingers curled in the palm of the hand;
instructing said individual to grab the free region of said lace and push said free region of lace against his belly;
instructing said individual while he is still hugging the lace with the words “snug hug”;
instructing said individual to drop said lace while his other hand is still holding onto said loop;
instructing said individual to visually identify the thumb and finger pinching said loop and that said loop will be used next to complete the tying of a knot;
instructing said individual to push said open length of lace through said hole formed by said loop;
instructing said individual to pinch said open length of lace closed to form a second loop;
instructing said individual to use his other hand to pinch said first loop;
instructing said individual to pull said loops tight together to form the knot;
instructing said individual to put on a shoe having a plain colored lace;
assisting said individual to identify what position is most comfortable for the individual to tie his shoe;
instructing said individual to pinch the lace between his thumb and index finger to form a first loop;
instructing said individual to slide fingers to bottom of said loop formed whilst keeping the remaining fingers curled in the palm of the hand;
instructing said individual to grab the free region of said lace and push said free region of lace against his belly;
instructing said individual while he is still hugging the lace with the words “snug hug”;
instructing said individual to drop said lace while his other hand is still holding onto said loop;
instructing said individual to visually identify the thumb and finger pinching said loop and that said loop will be used next to complete the tying of a knot;
instructing said individual to push said open length of lace through said hole formed by said loop;
instructing said individual to pinch said open length of lace closed to form a second loop;
instructing said individual to use his other hand to pinch said first loop; and
instructing said individual to pull said loops tight together to form the knot.

4. The method as claimed in claim 3 and further comprising the following steps:
instructing said individual to wear a shoe having a plain colored lace;
instructing said individual to fine tune the loops formed during the process of tying a knot, said fine tuning comprising adjusting the first and second loops so that the loops are close in size to each other;
instructing said individual to re-tighten the knot and to ensure that there is not excessive length of lace left over;
reinforcement of said “snug hug” technique of hugging the lace against the body during said knot tying exercise;
instructing said individual to tie a double knot, said double knot tying exercise comprising the steps of pinching the loops closed, taping the loops shut, forming an “X” at the top of the two loops, and pushing the first loop under and through the second loop and pulling the loops tight to form a double knot.

5. The method as claimed in claim 4 and further comprised of the following steps:
instructing said individual to avoid pulling on the ends of the loops of the double knot;
instructing said individual to use his pincer fingers of both hands to pull the double knot apart; and
instructing said individual to grab the lace aglets and pull them away from each other using both hands in a pinched position to untie the bow.
